(19) United States
(12) Patent Application Publication
(10) Pub. No.: US 2006/0224864 A1
(43) Pub. Date: Oct. 5, 2006

(54) System and method for handling multi-cycle non-pipelined instruction sequencing

(76) Inventors: Jonathan James DeMent, Austin, TX (US); Kurt Alan Feiste, Austin, TX (US); David Scott Ray, Georgetown, TX (US); David Shippy, Austin, TX (US); Albert James Van Norstrand JR., Round Rock, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/097,741

(22) Filed: Mar. 31, 2005

(51) Int. Cl. G06F 9/30

(52) U.S. Cl. 712/219

(57) ABSTRACT

A system and method for handling multi-cycle non-pipelined instruction sequencing. With the system and method, when a non-pipelined instruction is detected at an issue point, the issue logic initiates a stall that is for a minimum number of cycles that the fastest non-pipelined instruction could complete. The execution unit then takes over stalling until the non-pipelined instruction is actually completed. This allows the execution unit more time to accurately determine when the non-pipelined instruction will complete. Slightly before the execution unit has completed the instruction, it releases the stall to the issue logic. The timing of the execution unit releasing the stall signal is set so that a dependent instruction can bypass the result as soon as possible. In other words, the dependent instruction does not have to wait for the result to be written to the processor register file in order to obtain access to the result.

### BACKGROUND OF THE INVENTION

1. Technical Field

The present invention relates generally to an improved data processing system. More specifically, the present invention provides a system and method for handling multi-cycle non-pipelined instruction sequencing.

2. Description of Related Art

Typically, instructions such as multiplies, divides, square root, and/or other complicated math routines implemented by hardware are difficult and expensive to pipeline. The algorithms required to compute such complicated instructions are themselves complicated and typically must be broken down into iterative solutions. Since a loop is involved, such processing of complex instructions cannot be pipelined, or a collision could occur when the loop is attempted. The cost of implementing the algorithms directly is too high from both a power and area point of view when designing the processor.

Rather than pipeline these operations, many processors instead run a recursive loop through a simpler and shorter set of math operations that eventually produces the correct result for the operation. While this produces the correct result, the recursive loop requires additional processor cycles to complete, thereby increasing the latency in the processor. Moreover, dependent instructions, i.e. an instruction which requires the result of the non-pipelined instruction before it can execute, must wait for this recursive loop to complete before the results may be used in processing the dependent instruction, thereby increasing the latency even further.

Non-pipelined instructions, such as those that are processed using the recursive loops discussed above, are often difficult and cumbersome to process. Generally performance is lost by making early assumptions about how long a non-pipelined instruction will need to finish executing. Subsequent instructions are delayed until the non-pipelined instruction completes. The computed time for this delay is often incorrect and overly pessimistic. As a result, additional overhead is created in correcting the initial incorrect assumptions at execution time.

In order to address this latency, one approach described in U.S. Pat. No. 5,948,098, which is hereby incorporated by reference, a long-latency execution unit is added to avoid stalling due to the long-latency instruction. While this approach provides good performance, the additional long-latency execution unit requires additional on-chip area and power when compared to conventional processors.

Thus, it would be beneficial to have a system and method for handling complex instructions in a non-pipelined manner that does not suffer from the additional overhead associated with incorrect assumptions of execution completion times. In addition, for deeply pipelined processors that require multiple cycles to read and bypass from the register file, it would be beneficial to use existing bypass hardware, and bypass detection, rather than add new bypasses and detection hardware for handling these non-pipelined complex instructions.

### SUMMARY OF THE INVENTION

The present invention provides a system and method for handling multi-cycle non-pipelined instruction sequencing. With the system and method of the present invention, when a non-pipelined instruction is detected at an issue point, the issue logic initiates a stall that is for a minimum number of cycles that the fastest non-pipelined instruction could complete. The execution unit then takes over stalling until the non-pipelined instruction is nearly completed. This allows the execution unit more time to accurately determine when the non-pipelined instruction will complete.

Slightly before the execution unit has completed the instruction, it releases the stall to the issue logic. The issue unit issues the instruction a second time. The execution unit then inserts the result of the non-pipelined operation into the stage before the first bypass stages of pipelined results. The timing of the stall release and the insertion of the non-pipelined result into the pipelined instruction bypass network corresponds to the second issue of the non-pipelined instruction having the same timing and bypass characteristic as though a pipelined instruction was issued at the time of the second issue. Instruction result stalls and bypasses for the following instruction can be computed as though a pipelined instruction was issued at the time of the “second” issue of the non-pipelined operation.

In this way, the timing of the execution unit releasing the stall signal is set so that a dependent instruction can bypass the result as soon as possible. In other words, the dependent instruction does not have to wait for the result to be written to the processor register file in order to obtain access to the result. To the contrary, the dependent instruction can “bypass” the result as soon as it is available to help reduce stall latency. These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A is an exemplary diagram of a conventional execution unit of a central processing unit of a computing device;

FIG. 1B is an exemplary diagram of how the operand bypasses of the execution unit of FIG. 1A are used with an architectural register file;

FIG. 2 is an exemplary block diagram of a computer in accordance with the present invention;

FIG. 3 is an exemplary block diagram illustrating the interaction between an issue unit and an execution unit in accordance with the present invention;

FIG. 4 is an exemplary diagram of a pipeline in accordance with an exemplary embodiment of the present invention;

FIGS. 5A and 5B are an exemplary diagrams illustrating example instruction sequencing in accordance with an exemplary embodiment of the present invention;

FIG. 6 is an exemplary diagram of logic in an issue unit for controlling the stall of instructions in accordance with one exemplary embodiment of the present invention;

FIG. 7 is an exemplary diagram of a state machine in accordance with one exemplary embodiment of the present invention;

FIG. 8 is a flowchart outlining an exemplary operation of an issue unit in accordance with an exemplary embodiment of the present invention; and

FIG. 9 is a flowchart outlining an exemplary operation of an execution unit in accordance with an exemplary embodiment of the present invention.

### DETAILED DESCRIPTION OF THE PREFERRED EMBODIMENT

As stated above, the present invention provides a system and method for handling multi-cycle non-pipelined instruction sequencing. The mechanisms of the present invention operate so as to process complex instructions, i.e. multi-cycle instructions, in a non-pipelined manner while providing the result of the non-pipelined multi-cycle instruction to an appropriate stage of an instruction pipeline so as to permit pipelined execution of dependent instructions. Before providing a detailed explanation of the mechanisms and operation of the present invention, it is helpful to first describe the operation of a conventional pipelined execution unit.

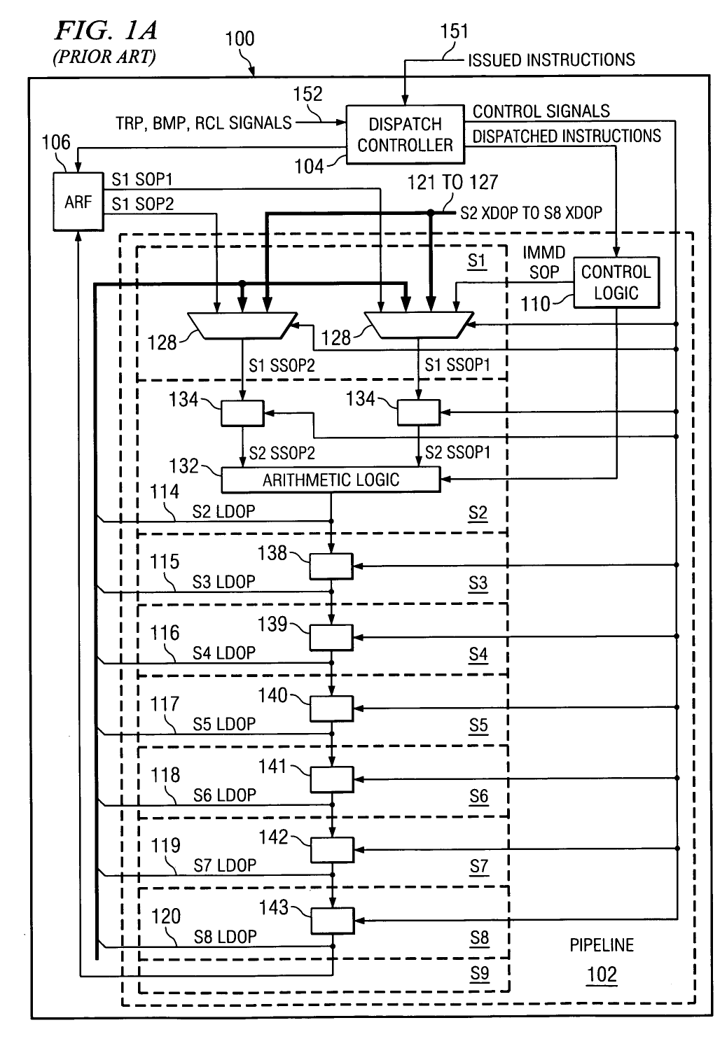

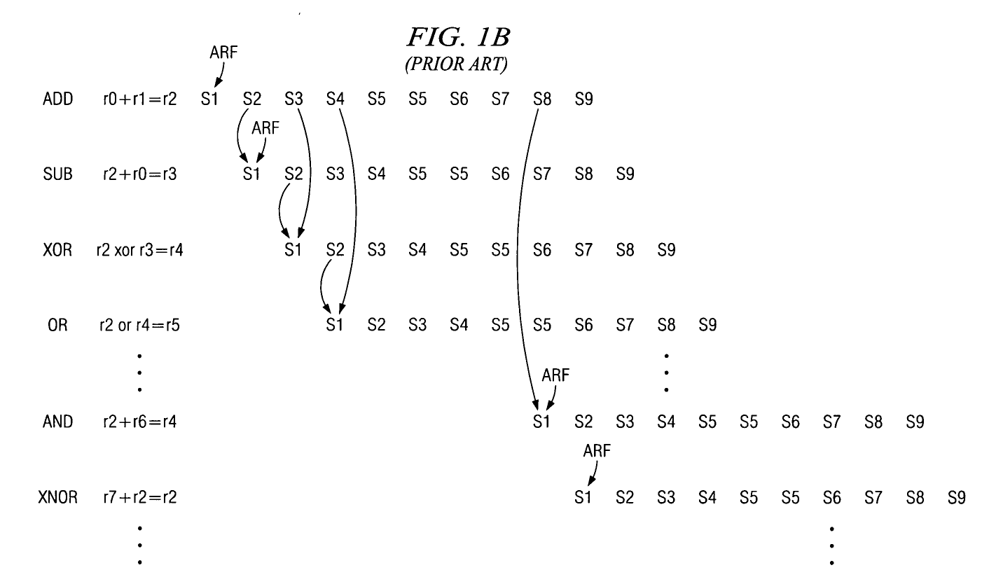

FIG. 1A is an exemplary illustration of a conventional execution unit 100 of a CPU (central processing unit) of a general purpose computer (not shown). The execution unit 100 includes a pipeline 102 to execute certain instructions of a computer program. The pipeline 102 has successive pipeline stages S1 to S9 for executing each instruction in the pipeline 102. The pipeline stages S1 to S9 include an operand selection stage S1, an operand processing (i.e., execute) stage S2, other pipeline stages S3 to S6, a validity determination stage S7, another pipeline stage S8, and an operand write stage S9. Each of the pipeline stages S1 and S3 to S9 occurs in one machine cycle and the operand processing stage S2 occurs in a variable number of machine cycles, as will be described later.

Each instruction 151 in the pipeline 102 is first issued by the CPU to the dispatch controller 104 of the execution unit 100. In turn, the dispatch controller 104 dispatches the issued instruction to the pipeline 102, at control logic 111, during the operand selection stage S1. The dispatch controller 104 also pre-decodes the instruction and, in response, generates control signals during the pipeline stages S1 to S9 for the instruction to control the operation of the architectural register file (ARF) 106 and the pipeline 102 in the manner described hereafter.

The operand selection stage S1 of the pipeline 102 includes multiplexers (MUXs) 128. During the operand selection stage S1 for each instruction in the pipeline 102, the MUXs 128 select one or more source operands S1 SSOP1 and/or S1 SSOP2 for processing by the operand processing stage S2 of the pipeline 102. As described next, this selection is made from among the source operands S1 SOP1 and S1 SOP2 received from the ARF 106, the local destination operands S2 LDOP to S8 LDOP received respectively from the operand bypasses 114 to 120, the external destination operands S2 XDOP to S8 XDOP received respectively from the operand bypasses 121 to 127 of another pipeline (not shown), and an immediate source operand IMMD SOP received from the control logic 110 of the pipeline 102.

The ARF 106 comprises the architectural registers of the computer. During the operand selection stage S1 for each instruction in the pipeline 102, the ARF 106 selectively provides source operands S1 SOP1 and S1 SOP2 from selected architectural registers of the ARF 106 to the operand selection stage S1 of the pipeline 102. The source operand S1 SOP1 or S1 SOP2 provided by the ARF 106 will be selected by one of the MUXs 128 if the dispatch controller 104 determines that the source operand S1 SOP1 or S1 SOP2 is currently available in one of the architectural registers of the ARF 106. This architectural register is specified by the instruction as a source.

However, for each instruction in the pipeline 102, the dispatch controller 104 may determine that the instruction requires an immediate source operand IMMD SOP from the control logic 110 instead of a source operand S1 SOP1 or S1 SOP2. In this case, one of the MUXs 128 selects the immediate source operand IMMD SOP.

The dispatch controller 104 may also determine during the operand selection stage S1 for each instruction in the pipeline 102 that the source operand S1 SOP1 or S1 SOP2 is not yet available in an architectural register of the ARF 106 but is in flight and available elsewhere. In this case, it may be available as one of the local destination (or result) operands S2 LDOP to S8 LDOP or one of the external destination operands S2 XDOP to S8 XDOP and then selected by one of the MUXs 128. The local destination operands S2 LDOP to S8 LDOP are generated by the pipeline 102 respectively during the pipeline stages S2 to S8 for other instructions in the pipeline 102. The external destination operands S2 XDOP to S8 XDOP are respectively generated during the pipeline stages S2 to S8 for instructions in another pipeline (designated by X, but not shown). This is done by respective external operand bypass sources of this pipeline.

In the operand processing stage S2, for each instruction in the pipeline 102, the one or more selected source operands S1 SSOP1 and/or S1 SSOP2 are first latched by the registers 134 of the operand processing stage S2 as the one or more selected source operands S2 SSOP1 and/or S2 SSOP2. Furthermore, in the operand processing stage S2, for the instruction, the control logic 110 of the pipeline 102 generates control signals that cause the arithmetic logic 132 of the operand processing stage S2 to process the one or more selected source operands S2 SSOP1 and/or S2 SSOP2 and generate in response a destination operand S2 LDOP for the instruction. These control signals are generated in response to decoding the instruction.

The pipeline stages S3 to S8, respectively, include registers 138 to 143. Thus, in the pipeline stage S3, for each instruction in the pipeline 102, the register 138 latches the local destination operand S2 LDOP generated in the operand processing stage S2 for the instruction as the local destination operand S3 LDOP. Similarly, in the pipeline stages S4 to S8 for each instruction in the pipeline, the registers 139 to 143, respectively, latch the local destination operands S3 LDOP to S7 LDOP that were respectively latched in the previous pipeline stages S3 to S7 as respectively the destination operands S4 LDOP to S8 LDOP. Thus, the destination operands S3 LDOP to S8 LDOP are all delayed versions of the destination operand S2 LDOP.

The pipeline stages S3 to S6 and S8 are needed since other processing is occurring in the execution unit 100. Moreover, the dispatch controller 104 makes the determination of whether an instruction is valid or invalid in the validity determination stage S7.

For each instruction in the pipeline 102 that is determined to be valid by the dispatch controller 104, the architectural register in the ARF 106 that is specified by the instruction as the destination stores the destination operand S8 LDOP during the operand write stage S9 for the instruction. Thus, the destination operand S8 LDOP for this particular instruction will now be available in the ARF 106 as a source operand S1 SOP1 or S1 SOP2 in the operand selection stage S1 for a later instruction in the pipeline 102 or another pipeline of the execution unit 100.

However, an instruction in the pipeline 102 may be invalid due to a branch mispredict, a trap, or an instruction recirculate. A branch mispredict will be indicated by a BMP (branch mispredict) signal 152 received by the dispatch controller 104 from another pipeline of the execution unit 100. A trap may be detected locally by the dispatch controller 104 or from TRP (trap) signals 152 received by the dispatch controller 104 from other pipelines in the execution unit. Moreover, an instruction recirculate will be indicated by RCL (instruction recirculate) signals 152 received by the dispatch controller 104 from the data cache (not shown) of the CPU when a data cache miss has occurred.

If the dispatch controller 104 determines that an instruction in the pipeline 102 is invalid, then the ARF 106 does not store the destination operand S8 LDOP for the instruction. In this way, the ARF 106 cannot be corrupted since the destination operand S8 LDOP for the instruction will not be stored in the ARF 106 until the dispatch controller 104 has determined that the instruction is valid.

However, later instructions in the pipeline 102 may depend on the local destination operands S2 LDOP to S8 LDOP of earlier instructions in the pipeline 102 and/or external destination operands S2 XDOP to S8 XDOP of earlier instructions in another pipeline which are in flight and have not yet been stored in the ARF 106. Similarly, later instructions in the other pipeline may depend on the local destination operands S2 LDOP to S8 LDOP of earlier instructions in the pipeline 102 which are in flight and have not yet been stored in the ARF 106. Thus, these local and external destination operands S2 LDOP to S8 LDOP to S2 XDOP to S8 XDOP must be made available with minimum latency to preserve the performance of the CPU. In order to do this, the execution unit 100 includes the operand bypasses 114 to 120 from the pipeline 102 and the operand bypasses 121 to 127 from another pipeline.

More specifically, the arithmetic logic 132 is coupled to the MUXs 128 by the operand bypass 114 for the operand processing stage S2. Similarly, the registers 138 to 143 are respectively coupled by the operand bypasses 115 to 120 for the intermediate stages S3 to S8 to the MUXs 128. In this way, the arithmetic logic 132 and the registers 138 to 143 are local operand bypass sources of the local destination operands S2 LDOP to S8 LDOP, respectively. And, as described earlier, the external operand bypass sources in another pipeline are coupled to the MUXs 128 by the operand bypasses 121 to 127 for the pipeline stages S2 to S8 to provide the external destination operands S2 XDOP to S8 XDOP.

Thus, in the operand selection stage S1, for each instruction in the pipeline 102, this particular instruction may specify as a source the same selected register in the ARF 106 that an earlier instruction in the pipeline 102 or another pipeline in the execution unit 100 specifies as a destination. This earlier instruction may be in the pipeline stage S2, . . . , S7, or S8 of the pipeline 102 or the other pipeline. In this case, the local or external destination operand S8 LDOP or S8 XDOP generated for the earlier instruction will not yet be available from the selected register, but will be available as the local or external destination operand S2 LDOP, . . . , S6 XDOP, or S7 XDOP on the corresponding operand bypass 114, . . . , 126, or 127. As a result, the MUXs 128 will select this local or external destination operand S2 LDOP, . . . , S6 XDOP, or S7 XDOP for processing by the arithmetic logic 132.

FIG. 1B illustrates this more precisely for the pipeline 102. As shown, the initial instruction ADD in the pipeline 102 obtains its source operands S1 SOP1 and S1 SOP2 from the registers r0 and r1 of the ARF 106 that are specified as sources during the operand selection stage S1 for the ADD instruction. During the operand processing stage S2 for the instruction ADD, the destination operand S2 LDOP is generated. However, the destination operand S8 LDOP is written to the register r2, of the ARF 106 that is specified as the destination, only during the operand write stage S9 for the instruction ADD. Thus, any instruction SUB, . . . , or AND that has its operand selection stage S1 during the pipeline stage S2, . . . , S7, or S8 of the instruction ADD and is dependent on the instruction ADD by specifying the register r2 as a source, must use the corresponding operand bypass 114, . . . , 119, or 120 to obtain the destination operand S2 LDOP, . . . , S2 LDOP, or S8 LDOP as the selected source operand S1 SOP1 or S1 SOP2. And, only for the instructions XNOR, etc., that have their operand selection stages S1 after the pipeline stage S2 to S8 of the instruction ADD, will the selected source operand S1 SOP1 or S1 SOP2 be directly available from the register r2. Therefore, since the ARF 106 is only written to in the operand write stage S9 for each instruction, the pipeline 102 must have operand bypasses 114 to 120 for the pipeline stages S2 to S8 in the pipeline 102 and must also be coupled to the operand bypasses 121 to 127 from the other pipeline.

In many CPUs, the arithmetic logic 132 is configured to process (i.e., perform arithmetic computations on) the one or more selected source operands S1 SSOP1 and/or S1 SSOP2 for all instructions of a predefined arithmetic instruction type. These may include performance critical arithmetic instructions that are critical to the performance of the CPU since they are commonly used. For each of the performance critical arithmetic instructions, the operand processing stage S2 occurs in one machine cycle. The instructions of the predefined arithmetic instruction type may also include non-performance critical arithmetic instructions that are not as frequently used and therefore not as critical to the performance of the CPU. For each of these non-performance critical arithmetic instructions, the operand processing stage S2 has substages and occurs in multiple machine cycles with the number of machine cycles varying depending on the instruction.

When a complex instruction, requiring multiple cycles to process, is issued to the execution unit, the instruction is processed by the execution unit using these substages of the operand processing stage s2 and arithmetic logic 132. Examples of such complex instructions include multiply, divide, dot-product, square root, and other complicated mathematical routines. While this instruction is being processed, all other instructions that would be issued to the pipeline 102 are stalled in the issue unit for a time period determined by an initial estimate of the time for completion of the complex instruction.

As mentioned above, these initial estimates of time of completion are often incorrect, and more or less processor cycles are actually necessary to process these instructions. If less processor cycles are required to process the instruction, then processor cycles are wasted while the issue unit continues to stall based on the initial prediction of time required to process the instruction.

If more processor cycles are required, such a miscalculation in the processing time of a complex multi-cycle non-pipelined instruction results in the issue unit having to recalculate the processing time of the instruction in the execution unit. Moreover, the issue unit also must stall issuing of instructions for additional processor cycles. This recalculation creates additional overhead in the processor and typically results in the issue unit stalling for more processor cycles than are necessary for the instruction's processing to be completed. As a result, processor cycles are wasted by the issue unit stalling issuance of additional instructions to the pipeline until the predicted amount of processor cycles pass.

The present invention avoids such overhead by providing logic in the issue unit and the execution unit to permit handling of multi-cycle non-pipelined instruction sequencing. With the mechanisms of the present invention, when a non-pipelined instruction is detected at an issue point, the issue logic initiates a stall that is for a minimum number of cycles that the fastest non-pipelined instruction could complete. The execution unit then takes over stalling until the non-pipelined instruction is actually completed. This allows the execution unit more time to accurately determine when the non-pipelined instruction will complete. Slightly before, or substantially at the same time that, the execution unit has completed the instruction, it releases the stall to the issue logic, which can then continue issuing instructions.

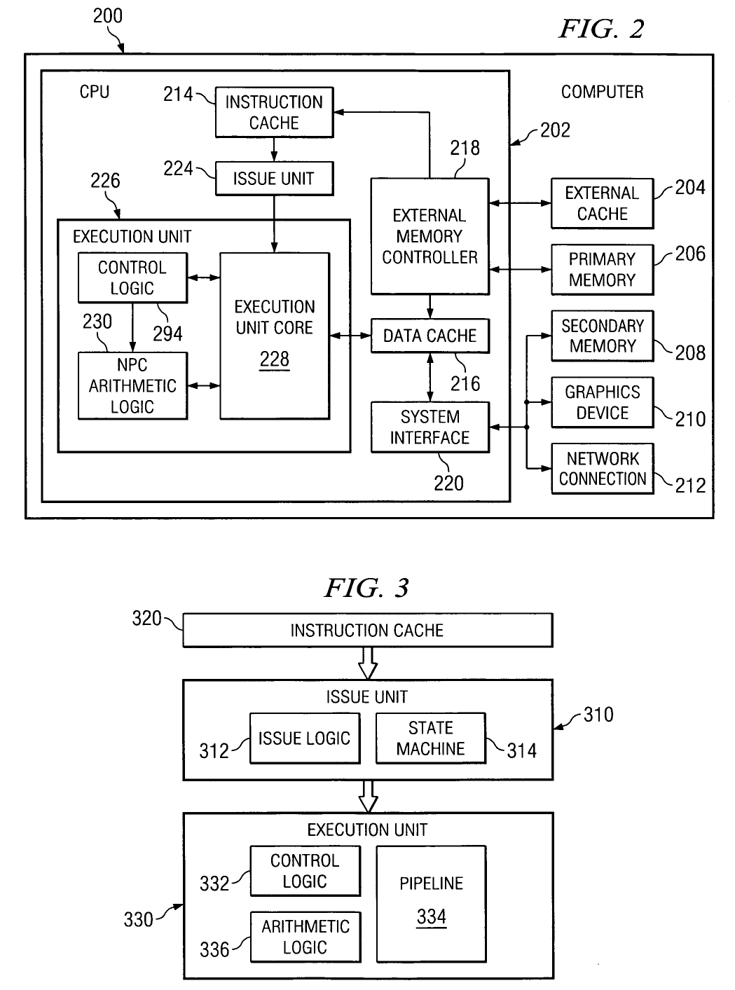

FIG. 2 is an exemplary block diagram of a computing device in which the exemplary aspects of the present invention may be implemented. As shown in FIG. 2, the computer 200 includes a CPU 202, an external cache 204, a primary memory 206, a secondary memory 208, a graphics device 210, and a network connection 212.

The CPU 202 includes an instruction cache 214, a data cache 216, an external memory controller 218 and a system interface 220. The external memory controller 218 connects to the instruction cache 214, the data cache 216, the external cache 204, and the primary memory 206. The system interface 220 connects to the data cache 216, the secondary memory 208, the graphics device 210, and the network connection 212.

The CPU 202 also includes an issue unit 224, which fetches instructions of a computer program from the instruction cache 214. The issue unit 224 then issues the fetched instructions for execution in the various pipelines in the execution unit 226. The CPU 202 further includes an execution unit 226, which includes an execution unit core 228, arithmetic logic 230 and control logic 294.

The execution unit core 228 includes an execution pipeline, such as pipeline 102 in FIG. 1A. Arithmetic logic 230 includes logic for executing pipelined and non-pipelined instructions. The present invention provides logic in the issue unit 224 and in the control logic 294 such that the issue unit 224 initially handles stalling of instructions when a multi-cycle non-pipelined instruction is being processed by the arithmetic logic 230. The issue unit 224 then hands off handling of stalling of instructions to the control logic 294 of execution unit 226 following an initial stall of instructions.

FIG. 3 is an exemplary block diagram illustrating the interaction between an issue unit and an execution unit in accordance with the present invention. As shown in FIG. 3, when the issue unit 310 fetches an instruction from the instruction cache 320 for issuance to the execution unit 330, the issue logic 312 of the issue unit determines whether the instruction is a pipeline instruction or a non-pipeline instruction. This determination may be made, for example, by processing the opcode (not shown) associated with the instruction and comparing the opcode to a table of pipeline instruction opcodes (not shown) resident in the issue unit 310. If the opcode is present in this table, then the associated instruction is a pipeline instruction. If the opcode is not in the table, then the associated instruction is a non-pipeline instruction.

For pipeline instructions, the issue unit 310 issues the instruction to the pipeline 334 of the execution unit 330 in a normal fashion. If the instruction is a non-pipeline instruction, the issue logic 312 of the issue unit 310 issues the non-pipeline instruction to the non-pipeline arithmetic logic 336 of the execution unit 330.

The issue logic 312 determines a minimum number of cycles for the fastest non-pipelined instruction to be completed in the execution unit 330 and initiates a stall in the issue unit 310 for that number of processor cycles. In a preferred embodiment of the present invention, this minimum number of cycles is a fixed number that is stored in the issue unit 310. The minimum number of cycles may be different for different processor architectures and execution units. In one exemplary processor architecture, the minimum number of cycles that the fastest non-pipelined instruction can be completed by the execution unit is 5 processor cycles.

The issue unit 310 then stalls issuance of more instructions to the execution unit 330 for the minimum number of cycles, e.g., 5 processor cycles. This initiation of a stall may involve, for example, the initialization of a counter to zero with the counter being incremented with each processor cycle. In other embodiments, the initiation of the stall and the stall itself are governed by the transition from one state to another in a state machine, as discussed in greater detail hereafter. Thus, in the exemplary embodiment, the issue unit 310 will not issue any more instructions to the execution unit 330 until the initial stall period has elapsed as determined by a counter/state machine, or the like, associated with or accessible by the issue unit 310.

After initiating the stall in the issue unit 310, and expiration of the initial stall period, the control of stalling of instructions being issued to the execution unit 330 is handed over to the control logic 332 in the execution unit 330. The control logic 332 of the execution unit, after the initial stall period has expired, determines if the processing of the instruction has been completed. If the processing of the instruction by the arithmetic logic 336 has not completed within the initial stall period, i.e. the minimum number of cycles in which a fastest non-pipelined instruction may be completed, then the control logic 332 of the execution unit 330 sends a signal to the issue unit 310 indicating that the issue unit 310 should continue to stall for another processor cycle. This determination and issuance of the stall signal from the execution unit 330 is performed with each subsequent processor cycle after the initial stall period until the instruction processing has been completed in the arithmetic logic 336.

If the instruction has been completed, either within the initial stall period or an extended stall period based on stall signals sent by the execution unit 330 to the issue unit 310, the control logic 332 sends a signal back to the issue unit 310 indicating completion of the instruction, or simply de-asserts a stall signal to thereby indicate completion of the instruction processing. As a result, the issue unit 310 releases the stall state of the issue unit 310 and reissues the instruction to the pipeline 334 of the execution unit 330 as a pipeline instruction. The execution unit 330 sees this reissued instruction as a pipeline instruction, e.g., an ADD instruction or the like, and executes it using pipeline 334.

In addition, the result of the execution of the non-pipelined instruction in the arithmetic logic 336 as described above is injected into an appropriate stage of the pipeline 334 using the bypass controls of the pipeline 334. In this way, the result of the reissued pipelined instruction is inserted into the pipeline 334 at a stage in which the actual result would have been present had the reissued pipeline instruction been actually executed in the pipeline 334. In this way, the result of the multi-cycle non-pipelined instruction is present in the pipeline 334 such that other dependent instructions may use the existing bypass controls of the pipeline to obtain the result of the multi-cycle non-pipelined instruction without having to access the register file, e.g., ARF 106. The result of the reissued pipeline instruction may then be written to the register file in a manner generally known in the art.

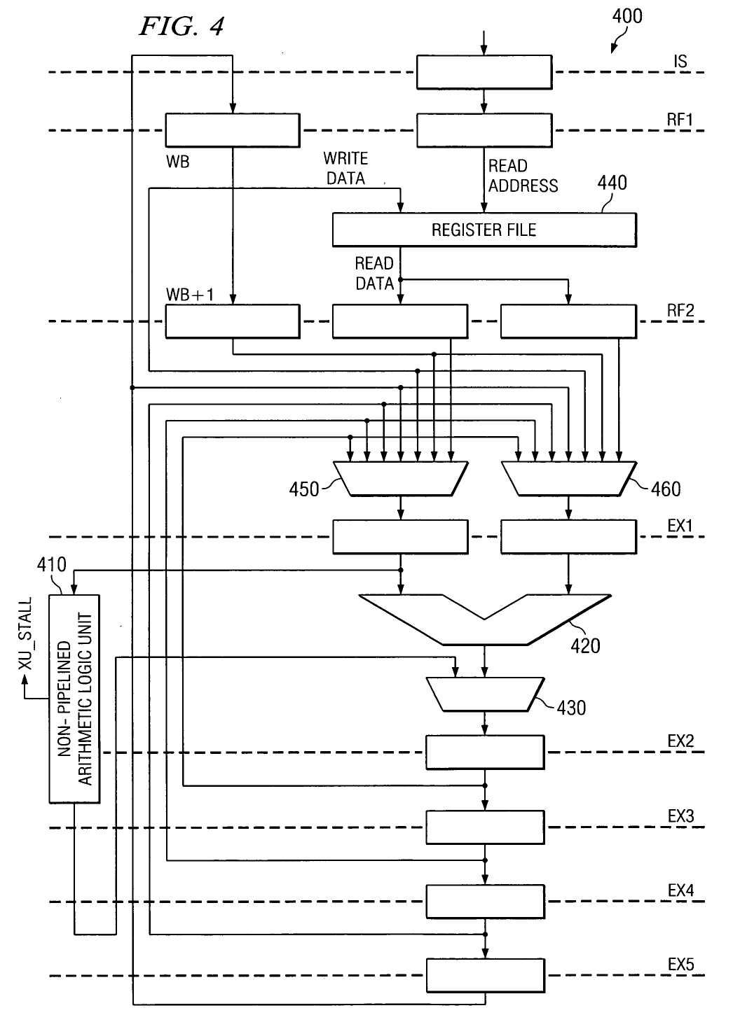

FIG. 4 is an exemplary diagram of a pipeline in accordance with an exemplary embodiment of the present invention. The pipeline shown in FIG. 4 is similar to that of FIG. 1A with the exception that an additional non-pipelined arithmetic logic unit 410 is provided for handling the execution of non-pipelined instructions. This non-pipelined arithmetic logic unit 410 may constitute sub-stages of arithmetic logic 132, for example, which are used to execute non-pipelined instructions. Adder 420 may constitute the primary arithmetic logic 132 used for pipelined instructions. The multiplexer 430 is provided for multiplexing the result of the non-pipelined arithmetic logic unit 410 and the result of the adder 420 (i.e. pipelined instructions). The control signal into multiplexer 430, used to select one of the two inputs, is provided by control logic, such as control logic 110 in FIG. 1.

As shown in FIG. 4, issued instructions, both pipelined and non-pipelined, are received in the execution unit at issue stage (IS). The read address of the issued instruction is then used to read operand data from the register file 440 during a first register file stage (RF1). The operand data read from the register file 440 is provided to multiplexers 450 and 460 during a second register file stage (RF2). A control signal, from control logic 110 for example, is input to multiplexers 450 and 460 to output selected inputs into the multiplexers 450 and 460 to adder 420 and non-pipelined arithmetic logic unit 410 during a first execute stage (EX1).

The output of adder 420 and non-pipelined arithmetic logic unit 410 are provided to multiplexer 430. A control signal, such as from control logic 410, is provided to multiplexer 430 for selecting between pipeline output from adder 420 and non-pipelined output from non-pipelined arithmetic unit 410. The output from multiplexer 430 is input to latches for each of the subsequent execute stages EX2 to EX5. The output of each latch in each execute stage EX2 to EX5 is input to multiplexers 450 and 460. The output of execute stage 5 (EX5) is also sent to write back latch (WB) and is written back to the register file 440.

The pipeline 400 shown in FIG. 4 operates under the control of control logic which is used to determine which operands are necessary for completion of instructions. The control logic includes dependency determination logic, dependency stall logic, and the like, for determining which stages (IS-EX5) that a required operand for a dependent instruction is in and whether a stall is necessary in order to obtain the required operands for the dependent instructions. The loop back from each execute stage (EX2-EX5) provides a bypass that permits the dependent instruction to obtain the operand before write back to the register file 440.

Thus, as shown in FIG. 4, the operands of non-pipelined instructions are sent to the non-pipeline arithmetic logic unit 410 during a first execute stage (EX1) and are also provided to adder 420. The non-pipeline arithmetic logic unit 410 operates on these operands to generate an output that is provided as one of the inputs to multiplexer 430. During this process, for a minimum number of cycles necessary for a fastest non-pipeline arithmetic operation to complete, i.e. an initial stall period, no further instructions are being issued to the execution unit, and thus, the pipeline 400, by the issue unit (see for example, issue unit 310 in FIG. 3). As a result, while the non-pipelined arithmetic logic unit 410 is executing operations on the operands of the non-pipelined instructions, no dependent instructions are being passed through the pipeline.

The input of operands to the non-pipelined arithmetic logic unit 410 initiates the assertion of an execution unit stall signal (XU_STALL) which is input to stall control logic in the issue unit, e.g., issue logic 312, at each processor cycle. While this XU_STALL signal is being asserted, the issue unit continues to stall on a cycle by cycle basis following the initial stall period.

Upon generation of an output by the non-pipelined arithmetic logic unit 410, it de-asserts the XU_STALL signal and the stalling of instructions being issued to the execution unit is lifted. The issue unit reissues the non-pipelined instruction as a pipelined instruction to the pipeline 400. The output of the non-pipelined arithmetic logic unit 410 is inserted into the pipeline 400 at stage EX1 via multiplexer 430.

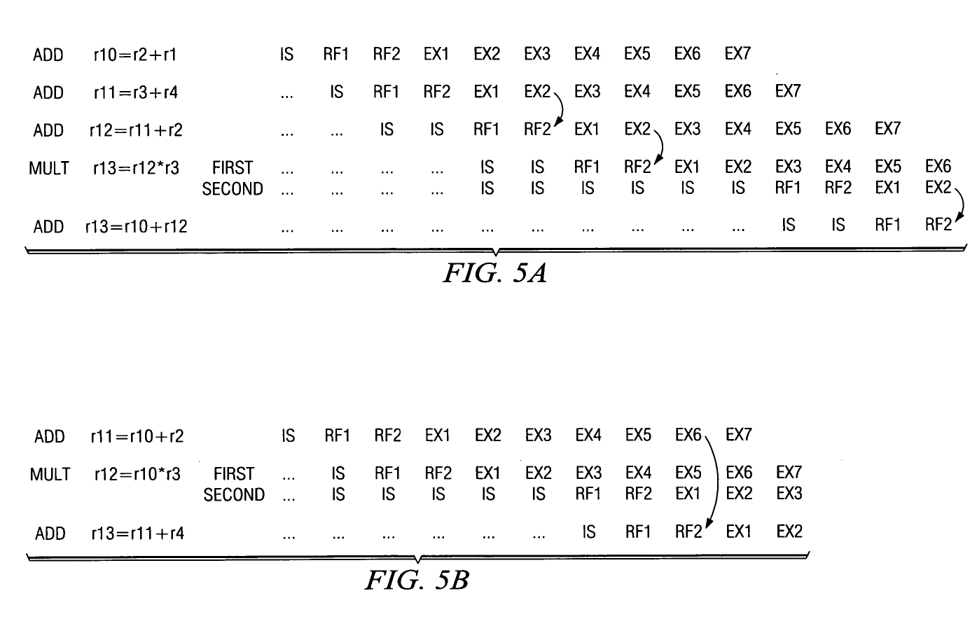

FIGS. 5A and 5B are an exemplary diagrams illustrating example instruction sequencing in accordance with an exemplary embodiment of the present invention. In the depicted instruction sequences, instruction results are bypassed to the RF2 stage, such as shown in FIG. 4, and can be bypassed from execute stages EX2, EX3, EX4, EX5, EX6 (write back (WB)), and EX7 (write back+1 (WB+1)).

In the instruction sequence shown in FIG. 5A, the operands r2 and r1 of a first pipelined add instruction, r10=r2+r1, are input to the pipeline 400. Thereafter, a second pipelined add instruction, r11=r3+r4, is issued to the pipeline 400. The second add instruction is not dependent upon the first add instruction.

A third pipelined add instruction, r12=r11+r2, is input to the pipeline 400, which is dependent upon the result of the second pipelined instruction. As shown in FIG. 5A, when the third pipelined add instruction is at the bypass stage (RF2), the result of the second pipelined add instruction is at execute stage EX2 and control signals are sent to the multiplexers 450 and 460 to bypass (denoted in the figure as the curved arrow going from EX2 to RF2) the result of the second pipelined add instruction for use in executing the third pipelined add instruction.

A non-pipelined multiply instruction, r13=r12*r3 is then issued to the execution unit. The non-pipelined multiply instruction is dependent upon the result of the third add instruction. When the non-pipelined multiply instruction is issued to the execution unit, an initial stall period is started such that no dependent instructions are issued until the result of the multiply instruction. The non-pipelined multiply instruction receives the result of the third add instruction from execution stage EX2 when the non-pipelined multiply instruction is at the second register file (RF2) stage.

As shown in FIG. 5A, the non-pipelined multiply instruction requires 5 processor cycles to complete in the non-pipelined arithmetic unit (see stall of second issuance of multiply instruction in the issue stage (IS)). The non-pipelined multiply instruction is then reissued a second time to the execution unit as a pipelined instruction. Since the result of the multiply instruction is available from the first issuance of the instruction, the second issuance of the instruction may pass through the pipeline. The result of the multiply instruction is made available by the bypass inputs to the multiplexers 450 and 460. Any subsequent dependent instructions, such as fourth pipelined add instruction r13=r10+r12, receive the necessary result of the multiply instruction from the second issuance of the multiply instruction to the execution unit (as shown by the curved arrow from EX2 to RF2).

FIG. 5B illustrates another example of an instruction sequence in which a second pipelined add instruction, r13=r11+r4, is dependent upon a first pipelined add instruction, r11=r10+r2, but is not dependent upon the non-pipelined multiply instruction, r12=r10*r3. FIG. 5B illustrates that while the pipelined instructions are not dependent upon the non-pipelined multiply instruction, the second pipelined add instruction is stalled due to the need to process the non-pipelined multiply instruction. As mentioned above, this sequencing is controlled by the dependency determination logic and dependency stall logic of a control logic unit, such as control logic 110, in the execution unit.

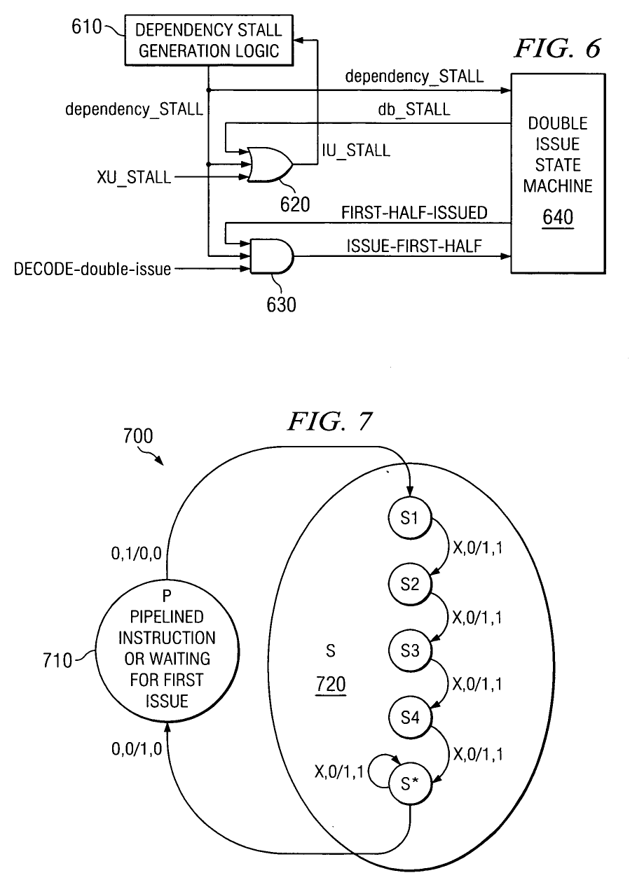

FIG. 6 is an exemplary diagram of logic in an issue unit for controlling the stall of instructions in accordance with one exemplary embodiment of the present invention. This logic may be, for example, part of the issue logic 312 of issue unit 310 in FIG. 3.

As shown in FIG. 6, dependency stall generation logic 610 is provided for determining whether to stall issuance of instructions to the execution unit between pipelined instructions. The dependency stall generation logic 610 computes and keeps track of the dependencies between issued instructions and controls the stalling of issuance of instructions to the execution unit.

The output of the dependency stall generation logic 610 is provided to OR gate 620 and AND gate 630. An output signal is asserted by the dependency stall generation logic 610 when issuance of instructions to the execution unit is to be stalled.

As shown in FIG. 6, the inputs to AND gate 630 are the dependency stall signal from the dependency stall generation logic 610, a decode double issue signal from a decoder (not shown), and a “first half issued” output signal from double issue state machine 640. The decode double issue signal is a signal that is asserted by the CPU's conventional instruction decoder (not shown) if the opcode of the instruction indicates that the instruction is a non-pipelined instruction. The first half issued signal is a signal that is asserted by the double issue state machine 640 when the double issue state machine 610 transitions from a pipelined instruction state to a “issued first half” state of a non-pipelined instruction, as discussed in further detail hereafter with regard to FIG. 7. When the decode double issue signal is asserted, the first half of a non-pipelined instruction has not been issued, and the dependency stall generation logic 610 does not indicate that a stall is required, the AND gate 630 outputs the “issue first half” signal to the double issue state machine 640.

The OR gate 620 receives as inputs, the execution unit stall signal XU_STALL, a dependency stall signal from dependency stall generation logic 610, and a double stall signal (db_STALL) from double issue state machine 640. If any one of these signals is asserted, the OR gate 620 outputs an issue unit stall signal (IU_STALL) to dependency stall generation logic 610.

The double stall signal is asserted by the double issued state machine 640 during an initial stall period to instigate a stall of the issuance of instructions to the execution unit for a minimum number of cycles for a fastest non-pipelined instruction to be executed by the execution unit in the non-pipelined arithmetic unit. The double issue state machine 640 may be a single state machine or a plurality of state machines that are used to keep track of the states of instructions being executed by the execution unit, whether pipelined or non-pipelined instructions.

FIG. 7 is an exemplary diagram of a state machine in accordance with one exemplary embodiment of the present invention. The arcs in FIG. 7 are labeled with a set of numerical values representing the state of the signals shown in FIG. 6 that result in the state transition. This set of numerical values are organized as follows: dependency_STALL, issue-first-half/first-half-issued, and db_STALL. An “X” value in these sets represents a “don't care” value meaning that the actual state of this signal is not considered when making the state transition.

As shown in FIG. 7, a simple state machine 700 is used to track the handling of double issued instructions. The state machine 700 may be a single state machine or may actually be implemented as two independent state machines: one two-state state machine may be used to track whether a double issue instruction has issued the first time or not and a second state machine may be used to control the stall of instructions using a counter, a series of state transitions, or the like. This second state machine may be combined with other stalling mechanisms which require stalling for a predetermined number of cycles, i.e. synchronization instructions.

As shown in the depicted state machine 700, if a double issue instruction is not in the issue stage (IS), or a double issue instruction is in the issue stage but has not issued the first time, the state machine 700 remains in state P 710. When a double issue instruction issues for the first time, the state transitions from state P 710 to state S1 of the “issued first half instruction” state 720. The state machine 700 output asserts the first-half-issued signal. The state machine 700 also asserts the db_STALL signal for a predetermined number of cycles by transitioning through states S1, S2, S3 . . . S*. This prevents the second issue of the non-pipelined instruction, and any other subsequent instructions, until an initial stall period has elapsed.

When the state machine 700 reaches state S*, the state machine 700 de-asserts the db_STALL signal. By this time, the execution unit will have determined if it needs additional stall cycles. If it does, the state machine 700 will stay in state S* until the XU_STALL signal is no longer asserted. When XU_STALL is no longer asserted, the stall condition is released and the non-pipelined instruction and subsequent instructions are permitted to issue. The execution unit ignores this second issue but the non-pipelined result is inserted back into the pipeline at the same location as if it were a pipelined instruction issued at the time. The control logic treats this second issue as though it were a normal issue of a pipelined instruction, and sets the multiplexer controls to forward data correctly to any subsequent instructions which are dependent on the data.

Thus, using the mechanisms described above, the present invention provides a system and method for handling multi-cycle non-pipelined instruction sequencing in an efficient manner where processor cycles required for executing the instruction are minimized and overhead due to miscalculation of processing times is minimized. With the present invention, the number of processor cycles used in waiting for completion of an non-pipelined instruction are exactly the number of processor cycles required to complete the non-pipelined instruction. That is, since the initial stall period is equal to the minimum number of cycles required by a fastest non-pipelined instruction execution, and extensions of this stall period are controlled on a processor cycle by cycle basis, processor cycles will never be wasted in stalling instructions unnecessarily.

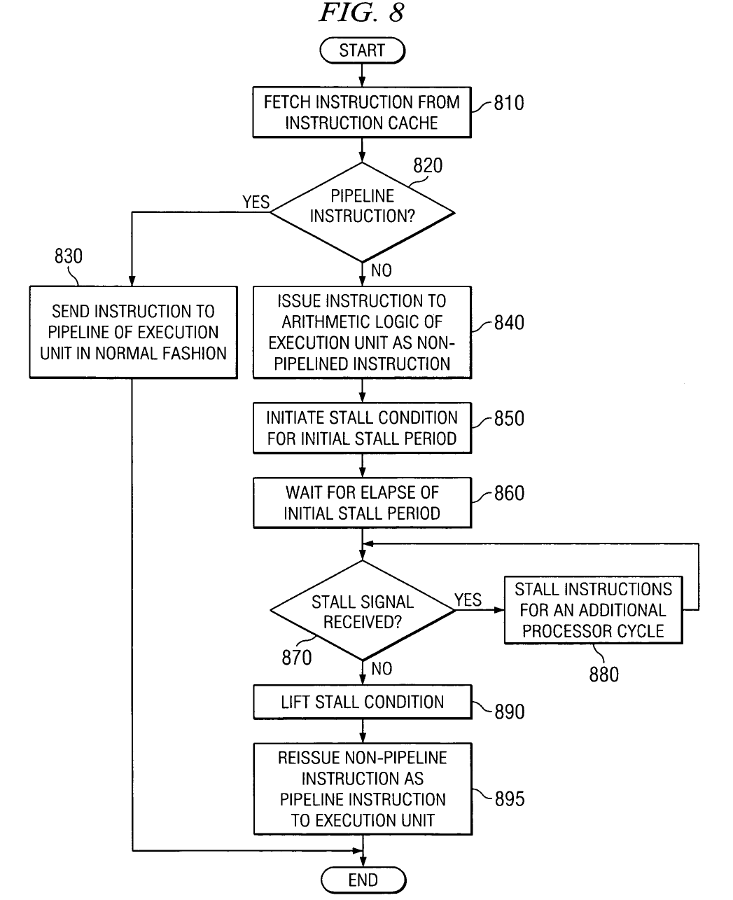

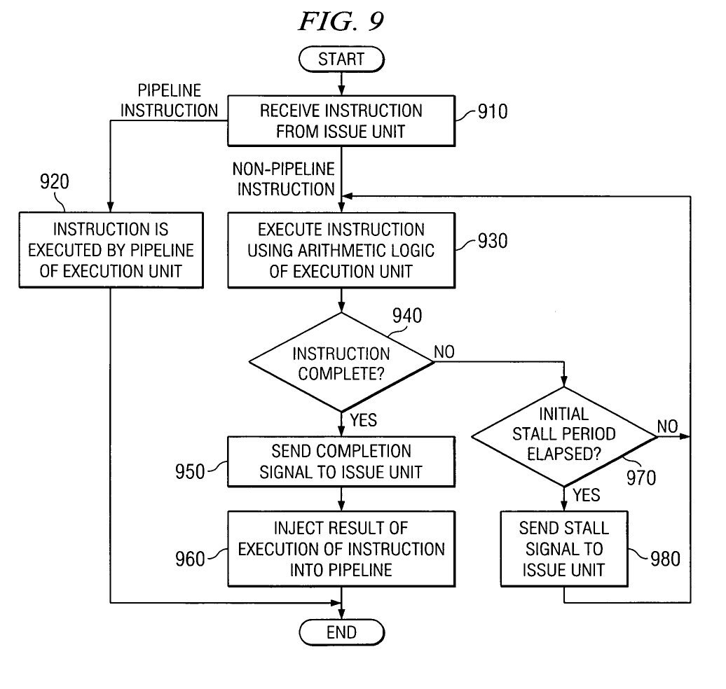

FIG. 8 is a flowchart outlining an exemplary operation of an issue unit in accordance with an exemplary embodiment of the present invention. FIG. 9 is a flowchart outlining an exemplary operation of an execution unit in accordance with an exemplary embodiment of the present invention. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

As shown in FIG. 8, the operation of the issue unit, e.g., issue unit 310 in FIG. 3, in accordance with the present invention, starts by fetching an instruction from the instruction cache (step 810). A determination is then made, by issue logic 312, for example, as to whether the instruction is a pipeline instruction (step 820). If so, the instruction is sent to the pipeline, such as by issue unit 310, of the execution unit in a fashion generally known in the art (step 830) and the operation terminates with regard to the operation according to the present invention. In actuality, the issue unit continues to fetch instructions from the instruction cache and the process described in FIG. 8 is repeated for each fetched instruction.

If the instruction is a non-pipeline instruction, then the issue unit issues the instruction to the arithmetic logic of the execution unit as a non-pipelined instruction (step 840). The issue unit then initiates a stall condition within the issue unit for an initial stall period that is equal to the minimum number of processor cycles required to complete a fastest non-pipelined instruction (step 850).

The issue unit then waits for the elapse of the initial stall period during which time no further instructions are issued to the execution unit by the issue unit (step 860). Following this initial stall period, the issue unit determines whether a stall signal is received from the execution unit (step 870). If a stall signal is received from the execution unit, the issue unit stalls for an additional processor cycle (step 880) and returns to step 870. If a stall signal is not received, then an instruction completion signal has been received and the stall condition of the issue unit is lifted (step 890). The issue unit then reissues, to the execution unit, the non-pipelined instruction as a pipeline instruction (step 895) and the operation terminates. Again, while the operation with regard to the present invention terminates here, the operation of the issue unit as a whole continues with the process shown in FIG. 8 being repeated for each subsequent fetched instruction.

Referring now to FIG. 9, the operation of the execution unit, e.g., execution unit 330 in FIG. 3, with regard to the present invention, begins with receipt of an instruction from the issue unit (step 910). If the instruction is a pipelined instruction, the instruction is executed by the pipeline of the execution unit in a manner generally known in the art (step 920). If the instruction is a non-pipelined instruction, it is executed by the arithmetic logic of the execution unit (step 930). A determination is made, such as by the non-pipelined arithmetic logic unit 410 in FIG. 4, for example, as to whether the instruction has completed execution (step 940). If so, a completion signal is sent, e.g., by the non-pipelined arithmetic logic unit 410, to the issue unit (step 950) and the result of the execution of the instruction is injected into the pipeline at a stage where the result of the instruction would have been present had the instruction been executed in the pipeline (step 960). As discussed previously, this completion signal may be and actual signal indicating completion of the non-pipelined instruction process or may be, for example, the de-assertion of an execution unit stall signal (XU_STALL).

Following completion of the processing of the non-pipelined instruction and injection of the result back into the pipeline, the operation then terminates with regard to the present invention. However, the actual operation of the execution unit continues with the process depicted in FIG. 9 being performed for each subsequent instruction received by the execution unit.

If the instruction execution has not completed, a determination is made, e.g., by the non-pipelined arithmetic logic unit 410, as to whether an initial stall period has elapsed (step 970). If not, then the operation returns to step 930. If the initial stall period has elapsed, and the instruction execution has not completed, then a stall signal, e.g., stall signal XU_STALL, is sent to the issue unit, e.g., from non-pipelined arithmetic logic unit 410, causing the issue unit to continue stalling instructions for another processor cycle (step 980). The operation then returns to step 930.

Thus, the present invention provides mechanisms for handling multi-cycle non-pipelined instruction scheduling that does not require additional area on chip and does not require additional power. Moreover, the present invention provides a mechanism for handling such non-pipelined instructions which eliminates the overhead associated with mispredictions of execution times for non-pipelined instructions.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for handling non-pipelined instructions, comprising:
issuing the non-pipelined instruction to an execution unit;
stalling issuance of other instructions to the execution unit for an initial stall period;
determining if a stall request is received from the execution unit following the initial stall period; and
extending stalling issuance of other instructions to the execution unit for an additional processor cycle if a stall request is received from the execution unit.

2. The method of claim 1, wherein the initial stall period is a minimum number of processor cycles required to complete execution of a fastest non-pipelined instruction execution.

3. The method of claim 1, further comprising:
discontinuing stalling issuance of other instructions if a stall request is not received from the execution unit; and
reissuing the non-pipelined instruction as a pipeline instruction to the execution unit if a stall request is not received.

4. The method of claim 1, wherein the method is performed within an issue unit of a processor of the data processing system.

5. The method of claim 1, further comprising:
receiving an instruction for processing by an execution unit; and
determining if the instruction is a pipelined instruction or a non-pipelined instruction.

6. The method of claim 5, wherein determining if the instruction is a pipelined instruction or a non-pipelined instruction includes:
processing an opcode associated with the instruction; and
comparing the opcode to a table of pipeline instruction opcodes, wherein the instruction is determined to be a non-pipelined instruction if the opcode is not present in the table of pipeline instruction opcodes.

7. The method of claim 1, wherein stalling issuance of other instructions to the execution unit for an initial stall period includes:
using a state machine to place an issue logic unit in a stall state; and
transitioning from one stall state to another until an initial stall period has expired.

8. The method of claim 7, wherein the state machine is in a non-stall state prior to issuance of the instruction to the execution unit and transitions to a first stall state upon issuance of the instruction to the execution unit.

9. The method of claim 3, wherein reissuing the non-pipelined instruction as a pipeline instruction to the execution unit if a stall request is not received, includes reissuing the non-pipelined instruction at a time that permits a result of the non-pipelined instruction to be bypassed to a next dependent instruction.

10. The method of claim 1, wherein the non-pipelined instruction is one of a multiply, a divide, a dot-product, or a square-root instruction.

11. A processor, comprising:
an issue logic unit; and
an execution unit coupled to the issue logic unit, wherein the issue logic unit includes logic for performing the following operations:
issuing a non-pipelined instruction to the execution unit;
stalling issuance of other instructions to the execution unit for an initial stall period;
determining if a stall request is received from the execution unit following the initial stall period; and
extending stalling issuance of other instructions to the execution unit for an additional processor cycle if a stall request is received from the execution unit.

12. The processor of claim 11, wherein the initial stall period is a minimum number of processor cycles required to complete execution of a fastest non-pipelined instruction execution.

13. The processor of claim 11, wherein the issue logic unit includes further logic for performing the following operations:
discontinuing stalling issuance of other instructions if a stall request is not received from the execution unit; and
reissuing the non-pipelined instruction as a pipeline instruction to the execution unit if a stall request is not received.

14. The processor of claim 11, wherein the issue logic unit further includes logic for performing the following operations:
receiving an instruction for processing by an execution unit; and
determining if the instruction is a pipelined instruction or a non-pipelined instruction.

15. The processor of claim 14, wherein the logic of the issue logic unit determines if the instruction is a pipelined instruction or a non-pipelined instruction by:
processing an opcode associated with the instruction; and
comparing the opcode to a table of pipeline instruction opcodes, wherein the instruction is determined to be a non-pipelined instruction if the opcode is not present in the table of pipeline instruction opcodes.

16. The processor of claim 11, wherein the logic of the issue logic unit stalls issuance of other instructions to the execution unit for an initial stall period by:
using a state machine to place the issue logic unit in a stall state; and
transitioning from one stall state to another until an initial stall period has expired.

17. The processor of claim 16, wherein the state machine is in a non-stall state prior to issuance of the instruction to the execution unit and transitions to a first stall state upon issuance of the instruction to the execution unit.

18. The processor of claim 13, wherein the logic of the issue logic unit reissues the non-pipelined instruction as a pipeline instruction to the execution unit if a stall request is not received, includes logic for reissuing the non-pipelined instruction at a time that permits a result of the non-pipelined instruction to be bypassed to a next dependent instruction.

19. The processor of claim 11, wherein the non-pipelined instruction is one of a multiply, a divide, a dot-product, or a square-root instruction.

20. A computer program product in a computer readable medium for handling non-pipelined instructions, comprising:
instructions for issuing the non-pipelined instruction to an execution unit;
instructions for stalling issuance of other instructions to the execution unit for an initial stall period;
instructions for determining if a stall request is received from the execution unit following the initial stall period; and
instructions for extending stalling issuance of other instructions to the execution unit for an additional processor cycle if a stall request is received from the execution unit.
